(19) United States
(12) Patent Application Publication
(10) Pub. No.: US 2004/0135273 A1
(43) Pub. Date: Jul. 15, 2004

(54) Methods of making a pattern of optical element shapes on a roll for use in making optical elements on or in substrates

(76) Inventors: Jeffery R. Parker, Richfield, OH (US); Timothy A. McCollum, Westlake, OH (US); Kurt R. Starkey, Strongsville, OH (US)

Correspondence Address: Donald L. Otto, Renner, Otto, Boisselle & Sklar, LLP, 19th Floor, 1621 Euclid Avenue, Cleveland, OH, 44115-2191, US

(21) Appl. No.: 10/744,276

(22) Filed: Dec. 23, 2003

Related U.S. Application Data
(63) Continuation-in-part of application No. 09/256,275, filed on Feb. 23, 1999, now Pat. No. 6,712,481.
Application No. 09/256,275 is a continuation-in-part of application No. 08/778,089, filed on Jan. 2, 1997, now Pat. No. 6,079,838.
Application No. 08/778,089 is a division of application No. 08/495,176, filed on Jun. 27, 1995, now Pat. No. 5,613,751.

(51) Int. Cl. B29D 11/00

(52) U.S. Cl. 264/2.5; 264/1.6

(57) ABSTRACT

The method involves cutting or forming one or more patterns of optical element shapes in the exterior surface of a sleeve or one or more curved substrates or films on a roll during rotation of the roll. Then at least a portion of the sleeve or substrates or films containing at least one pattern of optical element shapes is removed from the roll and the pattern of optical element shapes or a copy or inverse copy thereof is used to form a corresponding pattern of optical elements on or in an optical substrate.

### CROSS-REFERENCE TO RELATED APPLICATIONS

This application is a continuation-in-part of U.S. patent application No. 09/256,275, filed Feb. 23, 1999, which is a continuation-in-part of U.S. patent application Ser. No. 08/778,089, filed Jan. 2, 1997, now U.S. Pat. No. 6,079,838, dated Jun. 27, 2000, which is a division of U.S. patent application Ser. No. 08/495,176, filed Jun. 27, 1995, now U.S. Pat. No. 5,613,751, dated Mar. 25, 1997.

### FIELD OF THE INVENTION

This invention relates to methods of cutting or forming one or more patterns of optical element shapes in a sleeve or one or more curved substrates or films on a rotating roll, and removing at least a portion of the sleeve or substrates or films containing at least one pattern of optical element shapes from the roll for use in forming a corresponding pattern of optical elements on or in optical substrates.

### BACKGROUND OF THE INVENTION

It is generally known to provide optical elements on or in one or more surfaces of optically transmissive substrates including films, sheets or plates for redirecting light passing through the substrates. These optical elements may be individual three-dimensional optical elements of well defined shape each having a length and width substantially smaller than the length and width of the substrates containing the optical elements.

It is also generally known to cut or form a predetermined pattern of such optical element shapes in a flat sheet or plate for use in forming a corresponding pattern of optical element shapes on or in optical substrates. One of the drawbacks of this method is the substantial length of time required to cut the optical element shapes in the sheet or plate. Also it is extremely difficult to cut or form a pattern of optical element shapes in a three-dimensional shape.

### SUMMARY OF THE INVENTION

The length of time required to make one or more patterns of optical element shapes for use in forming one or more corresponding patterns of optical elements on or in optical substrates is greatly reduced in accordance with the present invention by using a tool to cut or form one or more such patterns of optical element shapes in an exterior surface of a sleeve or one or more curved substrates or films on a roll during rotation of the roll. The sleeve or substrates or films or at least a portion of the sleeve or substrates or films containing one or more patterns of optical element shapes is then removed from the roll and at least one pattern of the optical element shapes or a copy or inverse copy of the optical element shapes may be formed in any desired shape including three-dimensional shapes and used to form one or more corresponding patterns of optical elements on or in optical substrates.

The optical elements may be formed on or in the optical substrates as by an injection molding process, by heating and pressing the optical substrates against the optical element shapes, or by applying a flowable optical substrate material over the optical element shapes, having the flowable optical substrate material cure or solidify, and removing the cured or solidified optical substrate material from the optical element shapes.

The sleeve may be a preformed sleeve that is placed on the roll. Alternatively, the sleeve may be formed in situ on the roll by a deposition process. Also a release coating may be applied to the exterior surface of the roll prior to providing the sleeve on the roll. Moreover, one or more curved substrates or films may be suitably attached to the exterior surface of the roll.

These and other objects, advantages, features and aspects of the invention will become apparent as the following description proceeds.

To the accomplishment of the foregoing and related ends, the invention then comprises the features hereinafter fully described and particularly pointed out in the claims, the following description and the annexed drawings setting forth in detail certain illustrative embodiments of the invention, these being indicative, however, of but several of the various ways in which the principles of the invention may be employed.

### BRIEF DESCRIPTION OF THE DRAWINGS

In the annexed drawings:

FIGS. 1 through 3 are schematic perspective views of different forms of light emitting panel assemblies in accordance with this invention;

FIG. 4a is an enlarged plan view of a portion of a light output area of a panel assembly showing one form of pattern of light extracting deformities or optical elements on the light output area;

FIGS. 4b, c and d are enlarged schematic perspective views of a portion of a light output area of a panel assembly showing other forms of light extracting optical elements formed in or on the light output area;

FIG. 5 is an enlarged transverse section through the light emitting panel assembly of FIG. 3 taken generally on the plane of the line 5-5 thereof;

FIG. 6 is a schematic perspective view of another form of light emitting panel assembly in accordance with this invention;

FIG. 7 is a schematic top plan view of another form of light emitting panel assembly in accordance with this invention;

FIG. 8 is a schematic perspective view of another form of light emitting panel assembly in accordance with this invention;

FIG. 9 is a schematic top plan view of another form of light emitting panel assembly in accordance with this invention;

FIG. 10 is a schematic top plan view of still another form of light emitting panel assembly in accordance with this invention;

FIG. 11 is a side elevation view of the light emitting panel assembly of FIG. 10;

FIG. 11a is a fragmentary side elevation view showing a tapered or rounded end on the panel member in place of the prismatic surface shown in FIGS. 10 and 11;

FIG. 12 is a schematic top plan view of another form of light emitting panel assembly in accordance with this invention;

FIG. 13 is a schematic side elevation view of the light emitting panel assembly of FIG. 12;

FIGS. 14 and 15 are schematic perspective views of still other forms of light emitting panel assemblies in accordance with this invention;

FIGS. 16 and 17 are enlarged schematic fragmentary plan views of a surface area of a light panel assembly showing still other forms of optical elements in accordance with this invention formed on or in a surface of the panel member;

FIGS. 18 and 19 are enlarged longitudinal sections through one of the optical elements of FIGS. 15 and 17, respectively;

FIGS. 20 and 21 are enlarged schematic longitudinal sections through optical elements similar to FIGS. 18 and 19, respectively, except that the end walls of the optical elements are shown extending substantially perpendicular to the panel surface instead of perpendicular to their respective reflective/refractive surfaces as shown in FIGS. 18 and 19;

FIGS. 22 through 30 are enlarged schematic perspective views of panel surface areas containing various patterns of individual optical elements of other well defined shapes in accordance with this invention;

FIG. 31 is an enlarged schematic longitudinal section through another form of optical element in accordance with this invention;

FIGS. 32 and 33 are enlarged schematic top plan views of panel surface areas containing optical elements similar in shape to those shown in FIGS. 28 and 29 arranged in a plurality of straight rows along the length and width of the panel surface area;

FIGS. 34 and 35 are enlarged schematic top plan views of panel surface areas containing optical elements also similar in shape to those shown in FIGS. 28 and 29 arranged in staggered rows along the length of the panel surface areas;

FIGS. 36 and 37 are enlarged schematic top plan views of panel surface areas containing a random or variable pattern of different sized optical elements on the panel surface areas;

FIG. 38 is an enlarged schematic perspective view of a panel surface area showing optical elements in accordance with this invention increasing in size as the distance of the optical elements from the light source increases or intensity of the light increases along the length of the panel surface area;

FIGS. 39 and 40 are schematic perspective views showing different angular orientations of the optical elements along the length and width of a panel surface area;

FIGS. 41 and 42 are enlarged perspective views schematically showing how exemplary light rays emitted from a focused light source are reflected or refracted by different individual optical elements of well defined shapes in accordance with this invention;

FIG. 43 is a schematic perspective view showing a light emitting panel assembly similar to FIG. 42 placed on a front face of a display to provide front lighting for the display;

FIG. 44 is a schematic top plan view of another form of light emitting panel assembly in accordance with this invention for use in phototherapy treatment and the like;

FIGS. 45 through 47 are schematic side elevation view of still other forms of light emitting panel assemblies in accordance with this invention for use in phototherapy treatment and the like;

FIG. 48 is a schematic perspective view of a roll used to support a sleeve for rotation during cutting or forming of one or more patterns of optical element shapes in the exterior surface of the sleeve;

FIG. 49 is a schematic perspective view of the roll of FIG. 48 coated with a release coating;

FIG. 50 is a schematic perspective view of the roll of FIG. 48 with a sleeve provided on the roll;

FIG. 51 is a schematic perspective view of the roll of FIG. 48 with two curved substrates or films attached to the exterior surface of the roll;

FIG. 52 is an enlarged schematic perspective view of the roll of FIG. 50 showing a controller operated tool positioned for cutting or forming one or more patterns of optical element shapes in the exterior surface of the sleeve;

FIG. 53 is an end view of the roll of FIG. 52 showing a possible range of movements of the tool relative to the roll;

FIGS. 54 and 55 are schematic plan views of the roll of FIG. 53 showing a possible range of movements of the tool relative to the roll;

FIG. 56 is a schematic perspective view of the roll of FIG. 52 showing one or more patterns of optical element shapes cut or formed in the exterior surface of the sleeve;

FIG. 57 is a schematic perspective view of the roll of FIG. 51 showing one or more patterns of optical element shapes cut or formed in the exterior surface of the substrates or films attached to the exterior surface of the roll;

FIG. 58 is a schematic perspective view of the roll of FIG. 56 showing the sleeve cut lengthwise to facilitate removal of the entire sleeve from the roll;

FIG. 59 is a schematic perspective view of the sleeve of FIG. 58 removed from the roll;

FIG. 60 is a schematic plan view of a sleeve similar to FIG. 59 but showing different patterns of optical element shapes cut or formed in the exterior surface of the sleeve when on the roll;

FIG. 61 is a schematic side view showing at least a portion of a sleeve or substrate or film containing at least one pattern of optical element shapes or a copy or inverse copy thereof in a mold for molding a corresponding pattern of optical elements on or in an optical substrate;

FIG. 62 is a schematic side view showing an optical substrate being heated and pressed against at least a portion of a sleeve or substrate or film containing at least one pattern of optical element shapes or a copy or inverse copy thereof to form a corresponding pattern of optical elements on or in the optical substrate;

FIG. 63 is a schematic side view showing a flowable optical substrate material applied over the optical element shapes in at least a portion of a sleeve or substrate or film containing at least one pattern of optical element shapes or a copy or inverse copy thereof to form a corresponding pattern of optical elements on or in an optical substrate; and

FIG. 64 is a schematic plan view of one optical substrate having the optical elements formed on or in a surface thereof using at least a portion of a sleeve or substrate or film containing at least one pattern of optical element shapes or a copy or inverse copy thereof.

### DETAILED DESCRIPTION OF THE INVENTION

Referring now in detail to the drawings, and initially to FIG. 1, there is schematically shown one form of light emitting panel assembly 1 in accordance with this invention including a transparent light emitting panel or substrate 2 and one or more light sources 3 which emit light in a predetermined pattern in a light transition member or area 4 used to make the transition from the light source 3 to the substrate 2, as well known in the art. The light that is transmitted by the light transition area 4 to the transparent light emitting panel 2 may be emitted along the entire length of the panel or from one or more light output areas along the length of the panel as desired to produce a desired light output distribution to fit a particular application.

In FIG. 1 the light transition area 4 is shown as an integral extension of one end of the light emitting panel 2 and as being generally rectangular in shape. However, the light transition area may be of other shapes suitable for embedding, potting, bonding or otherwise mounting the light source. Also, reflective or refractive surfaces may be provided to increase efficiency. Moreover, the light transition area 4 may be a separate piece suitably attached to the light input surface 13 of the panel member if desired. Also, the sides of the light transition area may be curved to more efficiently reflect or refract a portion of the light emitted from the light source through the light emitting panel at an acceptable angle.

FIG. 2 shows another form of light emitting panel assembly or substrate 5 in accordance with this invention including a panel light transition area 6 at one end of the light emitting panel 7 with sides 8, 9 around and behind the light source 3 shaped to more efficiently reflect and/or refract and focus the light emitted from the light source 3 that impinges on these surfaces back through the light transition area 6 at an acceptable angle for entering the light input surface 18 at one end of the light emitting panel 7. Also, a suitable reflective material or coating 10 may be provided on the portions of the sides of the light transition areas of the panel assemblies of FIGS. 1 and 2 on which a portion of the light impinges for maximizing the amount of light or otherwise changing the light that is reflected back through the light transition areas and into the light emitting panels.

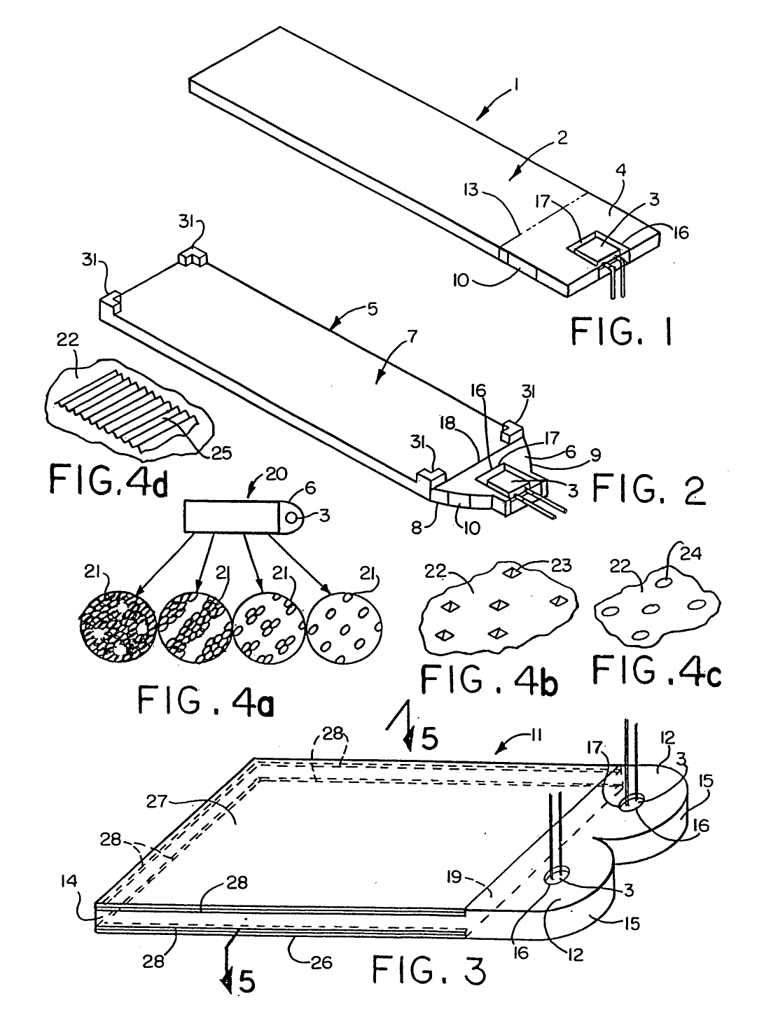

The panel assemblies shown in FIGS. 1 and 2 include a single light source 3, whereas FIG. 3 shows another light emitting panel assembly or substrate 11 in accordance with this invention including two light sources 3. Of course, it will be appreciated that the panel assemblies of the present invention may be provided with any number of light sources as desired, depending on the particular application.

The panel assembly 11 of FIG. 3 includes a light transition area 12 at one end of the light emitting panel 14 having reflective and/or refractive surfaces 15 around and behind each light source 3. These surfaces 15 may be appropriately shaped including for example curved, straight and/or faceted surfaces, and if desired, suitable reflective materials or coatings may be provided on portions of these surfaces to more efficiently reflect and/or refract and focus a portion of the light emitted for example from an incandescent light source which emits light in a 360° pattern through the light transition areas 12 into the light input surface 19 of the light emitting panel 14.

The light sources 3 may be mechanically held in any suitable manner in slots, cavities or openings 16 machined, molded or otherwise formed in the light transition areas of the panel assemblies. However, preferably the light sources 3 are embedded, potted or bonded in the light transition areas in order to eliminate any air gaps or air interface surfaces between the light sources and surrounding light transition areas, thereby reducing light loss and increasing the light output emitted by the light emitting panels. Such mounting of the light sources may be accomplished, for example, by bonding the light sources 3 in the slots, cavities or openings 16 in the light transition areas using a sufficient quantity of a suitable embedding, potting or bonding material 17. The slots, cavities or openings 16 may be on the top, bottom, sides or back of the light transition areas. Bonding can also be accomplished by a variety of methods that do not incorporate extra material, for example, thermal bonding, heat staking, ultrasonic or plastic welding or the like. Other methods of bonding include insert molding and casting around the light source(s).

A transparent light emitting material of any suitable type, for example acrylic or polycarbonate, may be used for the light emitting panels. Also, the panels may be substantially flat, or curved, may be a single layer or multi-layers, and may have different thicknesses and shapes. Moreover, the panels may be flexible, or rigid, and may be made out of a variety of compounds. Further, the panels may be hollow, filled with liquid, air, or be solid, and may have holes or ridges in the panels.

Each light source 3 may also be of any suitable type including, for example, any of the types disclosed in U.S. Pat. Nos. 4,897,771 and 5,005,108, assigned to the same assignee as the present application, the entire disclosures of which are incorporated herein by reference. In particular, the light sources 3 may be an arc lamp, an incandescent bulb which also may be colored, filtered or painted, a lens end bulb, a line light, a halogen lamp, a light emitting diode (LED), a chip from an LED, a neon bulb, a fluorescent tube, a fiber optic light pipe transmitting from a remote source, a laser or laser diode, or any other suitable light source. Additionally, the light sources 3 may be a multiple colored LED, or a combination of multiple colored radiation sources in order to provide a desired colored or white light output distribution. For example, a plurality of colored lights such as LEDs of different colors (red, blue, green) or a single LED with multiple colored chips may be employed to create white light or any other colored light output distribution by varying the intensities of each individual colored light.

A pattern of light extracting deformities or disruptions may be provided on one or both sides of the panel members or on one or more selected areas on one or both sides of the panel members, as desired. FIG. 4a schematically shows one such light surface area 20 on which a pattern of light extracting deformities or disruptions 21 is provided. As used herein, the terms deformities or disruptions, hereafter optical elements, are used interchangeably to mean any change in the shape or geometry of the panel surface and/or coating or surface treatment that causes a portion of the light to be emitted. The pattern of optical elements 21 shown in FIG. 4a includes a variable pattern which breaks up the light rays such that the internal angle of reflection of a portion of the light rays will be great enough to cause the light rays either to be emitted out of the panel through the side or sides on which the optical elements 21 are provided or reflected back through the panel and emitted out the other side.

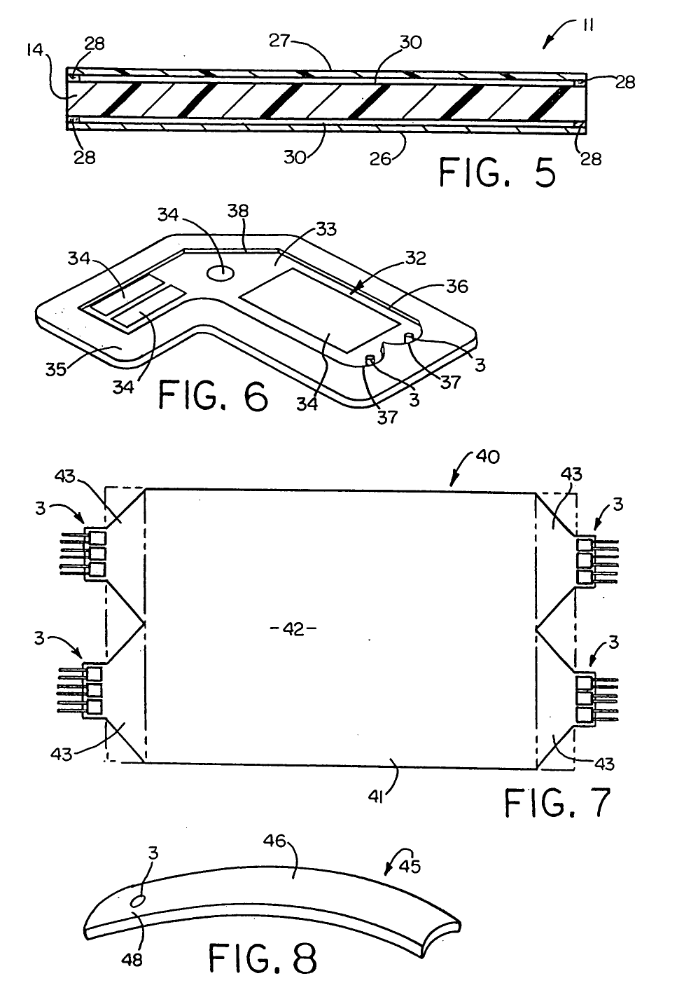

These optical elements 21 can be produced in a variety of manners, for example, by providing a painted pattern, an etched pattern, a machined pattern, a printed pattern, a hot stamped pattern, or a molded pattern or the like on selected light output areas of the panel members. An ink or printed pattern may be applied for example by pad printing, silk screening, ink jet, heat transfer film process or the like. The optical elements may also be printed on a sheet or film which is used to apply the optical elements to the panel member. This sheet or film may become a permanent part of the light panel assembly for example by attaching or otherwise positioning the sheet or film against one or both sides of the panel member similar to the sheet or film 27 shown in FIGS. 3 and 5 in order to produce a desired effect.

By varying the density, opaqueness or translucence, shape, depth, color, area, index of refraction, or type of optical elements 21 on an area or areas of the panels or substrates, the light output of the panels can be controlled. The optical elements may be used to control the percent of light emitted from any area of the panels. For example, less and/or smaller size optical elements 21 may be placed on panel areas where less light output is wanted. Conversely, a greater percentage of and/or larger optical elements may be placed on areas of the panels where greater light output is desired.

Varying the percentages and/or size of optical elements in different areas of the panels is necessary in order to provide a uniform light output distribution. For example, the amount of light traveling through the panels will ordinarily be greater in areas closer to the light source than in other areas further removed from the light source. A pattern of optical elements 21 may be used to adjust for the light variances within the panel members, for example, by providing a denser concentration of optical elements with increased distance from the light source 3 thereby resulting in a more uniform light output distribution from the light emitting panels.

The optical elements 21 may also be used to control the output ray angle distribution of the emitted light to suit a particular application. For example, if the panel assemblies are used to provide a liquid crystal display back light, the light output will be more efficient if the optical elements 21 cause the light rays to emit from the panels at predetermined ray angles such that they will pass through the liquid crystal display with low loss.

Additionally, the pattern of optical elements may be used to adjust for light output variances attributed to light extractions of the panel members. The pattern of optical elements 21 may be printed on the light output areas utilizing a wide spectrum of paints, inks, coatings, epoxies, or the like, ranging from glossy to opaque or both, and may employ half-tone separation techniques to vary the deformity 21 coverage. Moreover, the pattern of optical elements 21 may be multiple layers or vary in index of refraction.

Print patterns of optical elements 21 may vary in shapes such as dots, squares, diamonds, ellipses, stars, random shapes, and the like, and are desirably 0.006 square inch per deformity/element or less. Also, print patterns that are 60 lines per inch or finer are desirably employed, thus making the optical elements 21 in the print patterns nearly invisible to the human eye in a particular application thereby eliminating the detection of gradient or banding lines that are common to light extracting patterns utilizing larger elements. Additionally, the optical elements may vary in shape and/or size along the length and/or width of the panel members. Also, a random placement pattern of the optical elements may be utilized throughout the length and/or width of the panel members. The optical elements may have shapes or a pattern with no specific angles to reduce moire or other interference effects. Examples of methods to create these random patterns are printing a pattern of shapes using stochastic print pattern techniques, frequency modulated half tone patterns, or random dot half tones. Moreover, the optical elements may be colored in order to effect color correction in the panel members. The color of the optical elements may also vary throughout the panel members, for example to provide different colors for the same or different light output areas.

In addition to or in lieu of the patterns of optical elements 21 shown in FIG. 4a, other optical elements including prismatic surfaces, depressions or raised surfaces of various shapes using more complex shapes in a mold pattern may be molded, etched, stamped, thermoformed, hot stamped or the like into or on one or more areas of the panel member. FIGS. 4b and 4c show panel areas 22 on which prismatic surfaces 23 or depressions 24 are formed in the panel areas, whereas FIG. 4d shows prismatic or other reflective or refractive surfaces 25 formed on the exterior of the panel area. The prismatic surfaces, depressions or raised surfaces will cause a portion of the light rays contacted thereby to be emitted from the panel member. Also, the angles of the prisms, depressions or other surfaces may be varied to direct the light in different directions to produce a desired light output distribution or effect. Moreover, the reflective or refractive surfaces may have shapes or a pattern with no specific angles to reduce moire or other interference effects.

As best seen in the cross sectional view of FIG. 5, a back reflector (including trans reflectors) 26 may be attached or positioned against one side of the panel member 14 of FIG. 3 using a suitable adhesive 28 or other method in order to improve light output efficiency of the panel assembly 11 by reflecting the light emitted from that side back through the panel for emission through the opposite side. Additionally, a pattern of optical elements 21, 23, 24 and/or 25 may be provided on one or both sides of the panel member in order to change the path of the light so that the internal critical angle is exceeded and a portion of the light is emitted from one or both sides of the panel. Moreover, a transparent film, sheet or plate 27 may be attached or positioned against the side or sides of the panel member from which light is emitted using a suitable adhesive 28 or other method in order to produce a desired effect.

The member 27 may be used to further improve the uniformity of the light output distribution. For example, the member 27 may be a colored film, a diffuser, or a label or display, a portion of which may be a transparent overlay that may be colored and/or have text or an image thereon.

If adhesive 28 is used to adhere the back reflector 26 and/or film 27 to the panel, the adhesive is preferably applied only along the side edges of the panel, and if desired the end edge opposite the light transition areas 12, but not over the entire surface area or areas of the panel because of the difficulty in consistently applying a uniform coating of adhesive to the panel. Also, the adhesive changes the internal critical angle of the light in a less controllable manner than the air gaps 30 (see FIG. 5) which are formed between the respective panel surfaces and the back reflector 26 and/or film 27 when only adhered along the peripheral edges. Additionally, longer panel members are achievable when air gaps 30 are used. If adhesive were to be used over the entire surface, the pattern of deformities could be adjusted to account for the additional attenuation in the light caused by the adhesive.

Referring further to FIG. 2, the panel assembly 5 shown therein also includes molded posts 31 at one or more corners of the panel 7 (four such posts being shown) which may be used to facilitate mounting of the panel assembly and providing structural support for other parts or components, for example, a display panel such as a liquid crystal display panel as desired.

FIG. 6 shows another form of light emitting panel assembly 32 in accordance with this invention including a panel member 33, one or more light sources 3, and one or more light output areas 34. In addition, the panel assembly 32 includes a tray 35 having a cavity or recess 36 in which the panel assembly 32 is received. The tray 35 may act as a back reflector as well as end edge and/or side edge reflectors for the panel 33 and side and/or back reflectors 37 for the light sources 3. Additionally, one or more secondary reflective or refractive surfaces 38 may be provided on the panel member 33 and/or tray 35 to reflect a portion of the light around one or more corners or curves in a non-rectangular shaped panel member 33. These secondary reflective/refractive surfaces 38 may be flat, angled, faceted or curved, and may be used to extract a portion of the light away from the panel member in a predetermined pattern. FIG. 6 also shows multiple light output areas 34 on the panel member that emit light from one or more light sources 3.

FIG. 7 is a schematic illustration of still another form of light emitting panel assembly 40 in accordance with this invention including a panel member 41 having one or more light output areas 42 and one or more light transition areas (mixing areas) 43 containing a plurality of light sources 3 at one or both ends of the panel. Each transition area mixes the light from one or more light sources having different colors and/or intensities. In this particular embodiment, each of the light sources 3 desirably employs three colored LEDs (red, blue, green) in each transition mixing area 43 so that the light from the three LEDs can be mixed to produce a desired light output color that will be emitted from the light output area 42. Alternatively, each light source may be a single LED having multiple colored chips bonded to the lead film. Also, two colored LEDs or a single LED having two colored chips may be used for a particular application. By varying the intensities of the individual respective LEDs, virtually any colored light output or white light distribution can be achieved.

FIG. 8 shows yet another form of light emitting panel assembly 45 in accordance with this invention including a light emitting panel member or substrate 46 and a light source 3 in a light transition area 48 integral with one end of the panel member. In this particular embodiment, the panel member 46 is three-dimensionally curved, for example, such that light rays may be emitted in a manner that facilitates aesthetic design of a lighted display.

FIG. 9 schematically shows another form of light emitting panel assembly 50 in accordance with this invention, including a panel member 51 having multiple light output areas 52, and mounting posts and/or mounting tabs 53. This particular panel assembly 50 may serve as a structural member to support other parts or components as by providing holes or cavities 54, 55 in the panel member 51 which allow for the insertion of modular components or other parts into the panel member. Moreover, a separate cavity or recess 56 may be provided in the panel member 51 for receipt of a correspondingly shaped light transition area 57 having one or more light sources 3 embedded, bonded, cast, insert molded, epoxied, or otherwise mounted or positioned therein and a curved reflective or refractive surface 58 on the transition area 57 and/or wall of the cavity or recess 56 to redirect a portion of the light in a predetermined manner. In this way the light transition area 57 and/or panel member may be in the form of a separate insert which facilitates the easy placement of the light source in a modular manner. A reflector 58 may be placed on the reflective or refractive surface of the cavity or recess 56 or insert 57. Where the reflector 58 is placed on the reflective or refractive surface of the cavity or recess 56, the cavity or recess may act as a mold permitting transparent material from which the transition area 57 is made to be cast around one or more light sources 3.

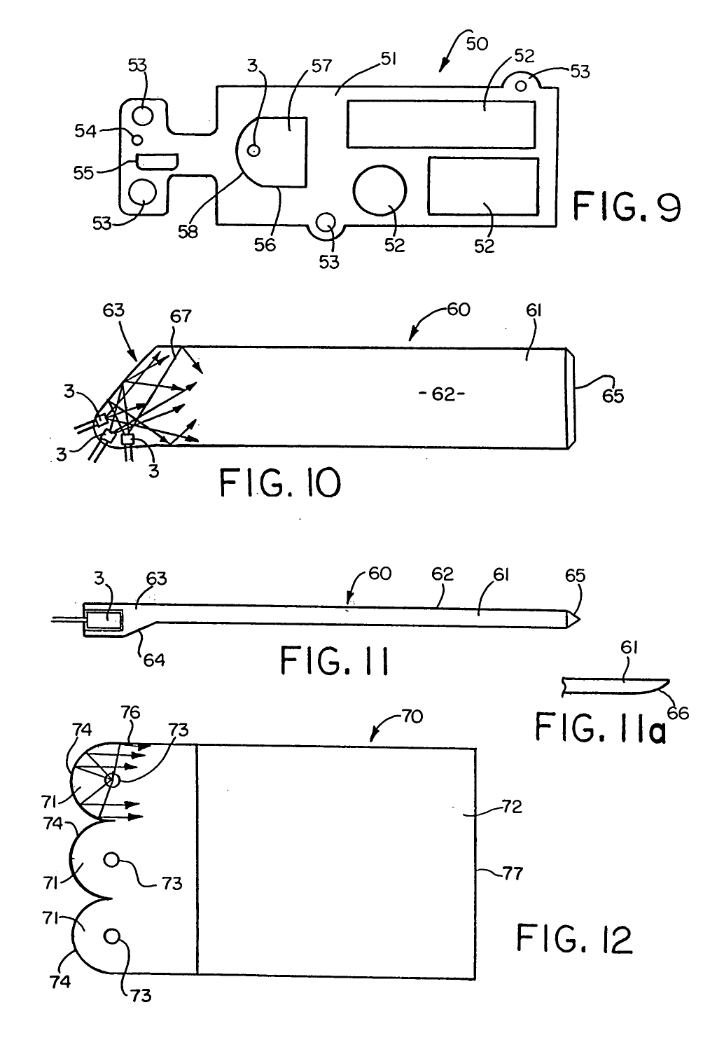

FIGS. 10 and 11 schematically show another form of light emitting panel assembly 60 in accordance with this invention including a panel member 61 having one or more light output areas 62. In this particular embodiment, an off-axis light transition area 63 is provided that is thicker in cross section than the panel member to permit use of one or more light sources 3 embedded or otherwise mounted in the light transition area that are dimensionally thicker than the panel member. Also, a three-dimensional reflective surface 64 (FIG. 11) may be provided on the transition area 63. Moreover, a prism 65 (FIG. 11) or tapered, rounded, or otherwise shaped end 66 (FIG. 11a) may be provided at the end of the panel opposite the light sources 3 to perform the function of an end reflector. The light sources 3 may be oriented at different angles relative to each other and offset to facilitate better mixing of the light rays 67 in the transition area 63 as schematically shown in FIG. 10 and/or to permit a shorter length transition area 63 to be used.

FIGS. 12 and 13 schematically show still another form of light emitting panel assembly 70 in accordance with this invention which includes one or more light transition areas 71 at one or both ends of the panel member 72 each containing a single light source 73. The transition area or areas 71 shown in FIGS. 12 and 13 collect light with multiple or three-dimensional surfaces and/or collect light in more than one plane. For example each transition area 71 shown in FIGS. 12 and 13 has elliptical and parabolic shape surfaces 74 and 75 in different planes for directing the light rays 76 into the panel member at a desired angle.

Providing one or more transition areas at one or both ends of the panel member of any desired dimension to accommodate one or more light sources, with reflective and/or refractive surfaces on the transition areas for redirecting the light rays into the panel member at relatively low angles allows the light emitting panel member to be made much longer and thinner than would otherwise be possible. For example the panel members of the present invention may be made very thin, i.e., 0.125 inch thick or less.

FIG. 14 schematically illustrates still another form of light emitting panel assembly 80 in accordance with this invention including a light emitting panel 81 and one or more light sources 3 positioned, embedded, potted, bonded or otherwise mounted in a light transition area 82 that is at an angle relative to the panel member 81 to permit more efficient use of space. An angled or curved reflective or refractive surface 83 is provided at the junction of the panel member 81 with the transition area 82 in order to reflect/refract light from the light source 3 into the body of the panel member 81 for emission of light from one or more light emitting areas 84 along the length of the panel member.

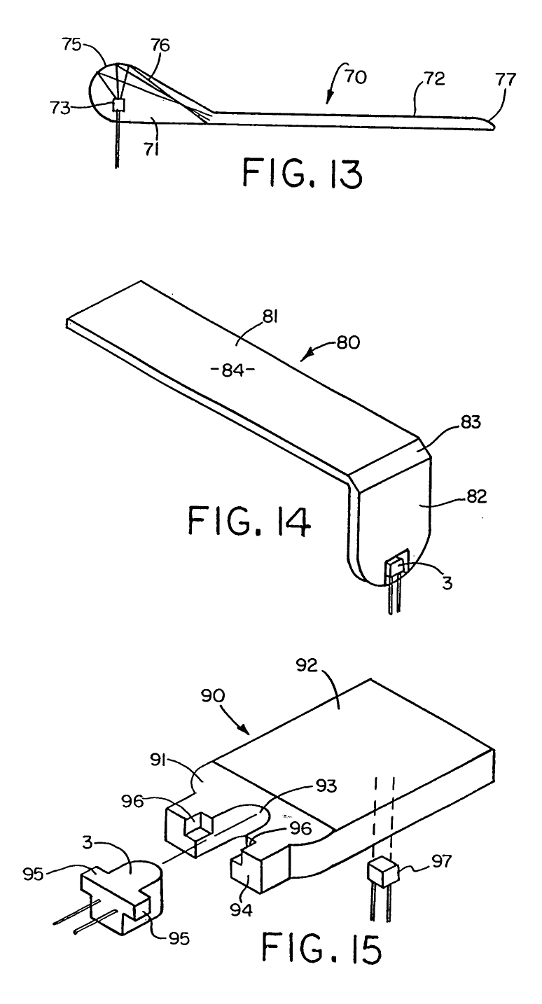

FIG. 15 schematically illustrates still another form of light emitting panel assembly 90 in accordance with this invention including a light transition area 91 at one or both ends of a light emitting panel member 92 containing a slot 93 for sliding receipt of an LED or other suitable light source 3. Preferably the slot 93 extends into the transition area 91 from the back edge 94, whereby the light source 3 may be slid and/or snapped in place in the slot from the back, thus allowing the transition area to be made shorter and/or thinner. The light source 3 may be provided with wings, tabs or other surfaces 95 for engagement in correspondingly shaped recesses or grooves 96 or the like in the transition area 91 for locating and, if desired, securing the light source in place. Also, the light source 3 may be embedded, potted, bonded or otherwise secured within the slot 93 in the light transition area 91 of the panel member 92. Light from a secondary light source 97 may be projected through the panel member 92 for indication or some other effect.

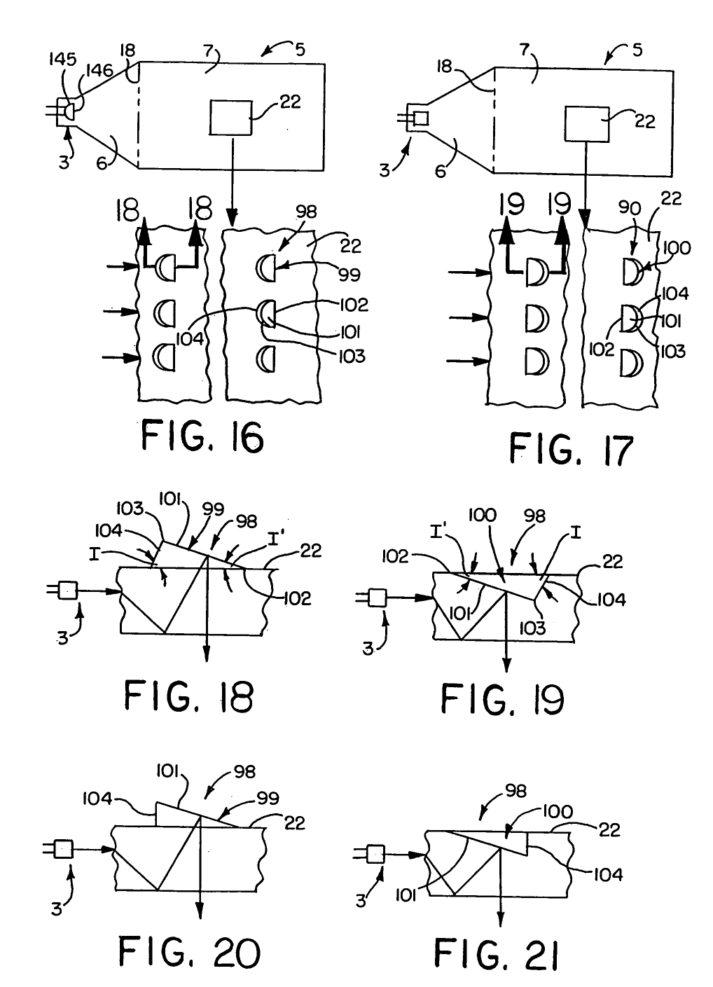

FIGS. 16 through 19 show other optical elements 98 in accordance with this invention which may either be individual projections 99 on the respective panel substrate surface areas 22 or individual depressions 100 in such panel surface areas. In either case, the optical elements deformities 98 differ from the optical elements shown in FIGS. 4a, 4b, 4c and 4d in that each of the deformities 98 has a well defined shape including a reflective or refractive surface 101 that intersects the respective panel surface area 22 at one edge 102 and has a uniform slope throughout its length for more precisely controlling the emission of light by each of the optical elements. Along a peripheral edge portion 103 of each reflective/refractive surface 101 is an end wall 104 of each optical element 98 that intersects the respective panel surface area at a greater included angle I than the included angle I′ between the reflective/refractive surfaces 101 and the panel surface area 22 (see FIGS. 18 and 19) to minimize the projected surface area of the end walls on the panel surface area. This allows more optical elements 98 to be placed on or in the panel surface areas than would otherwise be possible if the projected surface areas of the end walls 104 were substantially the same as or greater than the projected surface areas of the reflective/refractive surfaces 101.

In FIGS. 16 and 17 the peripheral edge portions 103 of the reflective/refractive surfaces 101 and associated end walls 104 are curved in the transverse direction. Also, in FIGS. 18 and 19 the end walls 104 of the optical elements 98 are shown extending substantially perpendicular to the reflective/refractive surfaces 101 of the optical elements. Alternatively, such end walls 104 may extend substantially perpendicular to the panel surface areas 22 as schematically shown in FIGS. 20 and 21. This virtually eliminates any projected surface area of the end walls 104 on the panel surface areas 22 whereby the density of the optical elements on the panel surface areas may be even further increased.

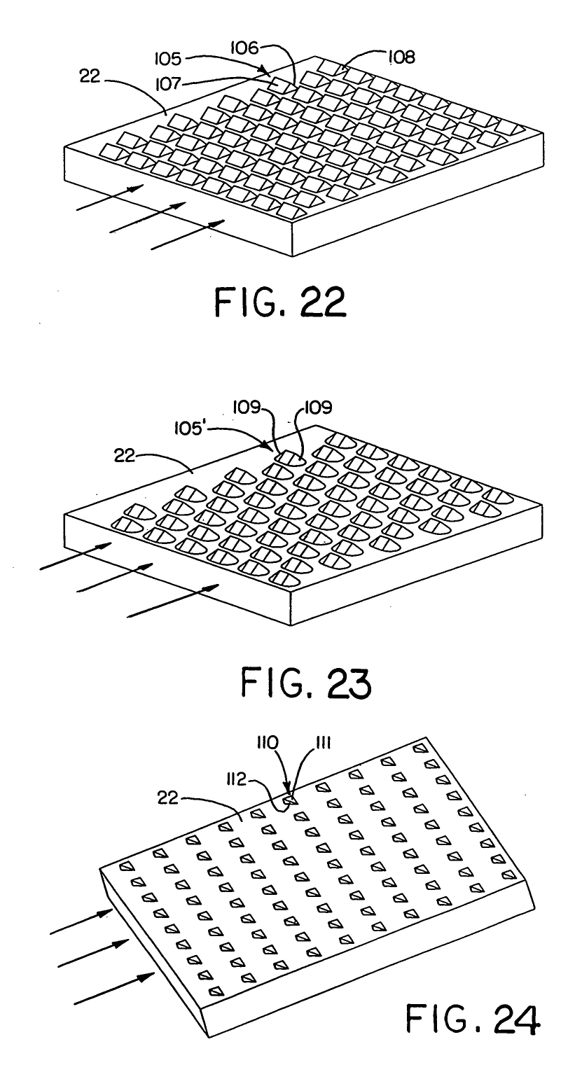

The optical elements may also be of other well defined shapes to obtain a desired light output distribution from a panel surface area. FIG. 22 shows individual optical elements 105 on a panel surface area 22 each including a generally planar, rectangular reflective/refractive surface 106 and associated side wall 107 of a uniform slope throughout their length and width and generally planar end walls 108. Alternatively, the optical elements 105′ may have rounded or curved end walls 109 as schematically shown in FIG. 23.

FIG. 24 shows individual optical elements 110 on a panel surface area 22 each including a planar, sloping triangular shaped reflective/refractive surface 111 and associated planar, generally triangularly shaped side walls or end walls 112. FIG. 25 shows individual optical elements 115 each including a planar sloping reflective/refractive surface 116 having angled peripheral edge portions 117 and associated angled side and end walls 118 and 119.

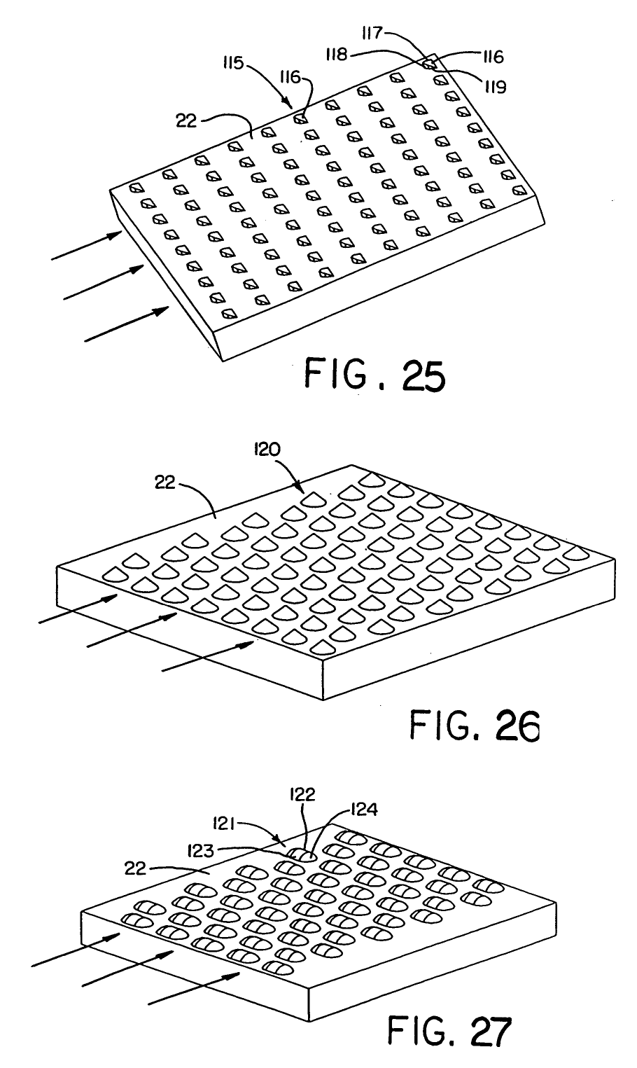

FIG. 26 shows individual optical elements 120 which are generally conically shaped, whereas FIG. 27 shows individual optical elements 121 each including a rounded reflective/refractive surface 122 and rounded side wall 123 and rounded or curved end walls 124 all blended together.

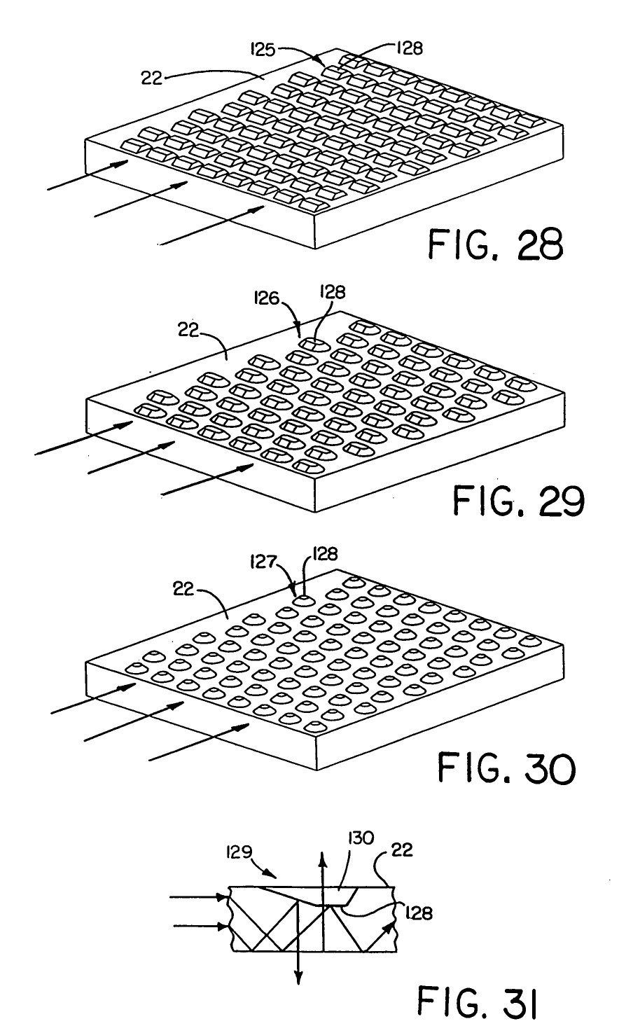

Regardless of the particular shape of the reflective/refractive surfaces and end and side walls of the individual optical elements, such optical elements may also include planar surfaces intersecting the reflective/refractive surfaces and end and/or side walls in parallel spaced relation to the panel surface areas 22. FIGS. 28 through 30 show optical elements 125, 126 and 127 in the form of individual projections on a panel surface area 22 having representative shapes similar to those shown in FIGS. 22, 23 and 26, respectively, except that each optical element is intersected by a planar surface 128 in parallel spaced relation to the panel surface area 22. In like manner, FIG. 31 shows one of a multitude of optical elements 129 in the form of individual depressions 130 in a panel surface area 22 each intersected by a planar surface 128 in parallel spaced relation to the general planar surface of the panel surface area 22. Any light rays that impinge on such planar surfaces 128 at internal angles less than the critical angle for emission of light from the panel surface area 22 will be internally reflected by the planar surfaces 128, whereas any light rays impinging on such planar surfaces 128 at internal angles greater than the critical angle will be emitted by the planar surfaces with minimal optical discontinuities as schematically shown in FIG. 31.

Where the optical elements are projections on the panel surface area 22, the reflective/refractive surfaces extend at an angle away from the panel in a direction generally opposite to that in which the light rays from the light source 3 travel through the panel as schematically shown in FIGS. 18 and 20. Where the optical elements are depressions in the panel surface area, the reflective/refractive surfaces extend at an angle into the panel in the same general direction in which the light rays from the light source 3 travel through the panel member as schematically shown in FIGS. 19 and 20.

Regardless of whether the optical elements are projections or depressions on or in the panel surface areas 22, the slopes of the light reflecting/refractive surfaces of the optical elements may be varied to cause the light rays impinging thereon to be either refracted out of the light emitting panel or reflected back through the panel and emitted out the opposite side of the panel which may be etched to diffuse the light emitted therefrom or covered by a transparent film, sheet or plate similar to the film 27 shown in FIGS. 3 and 5 to produce a desired effect.

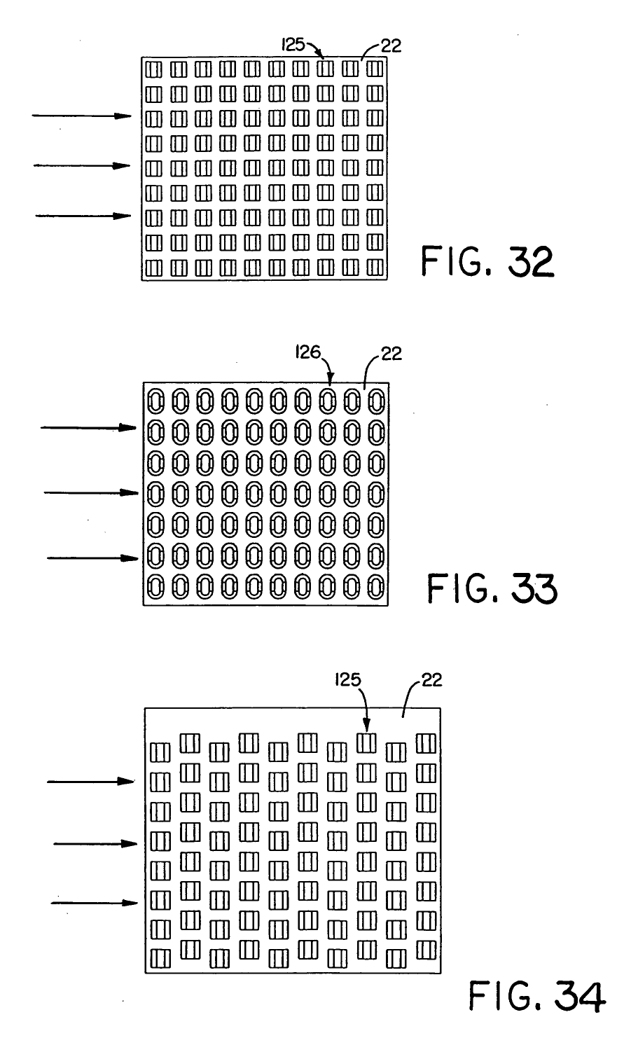

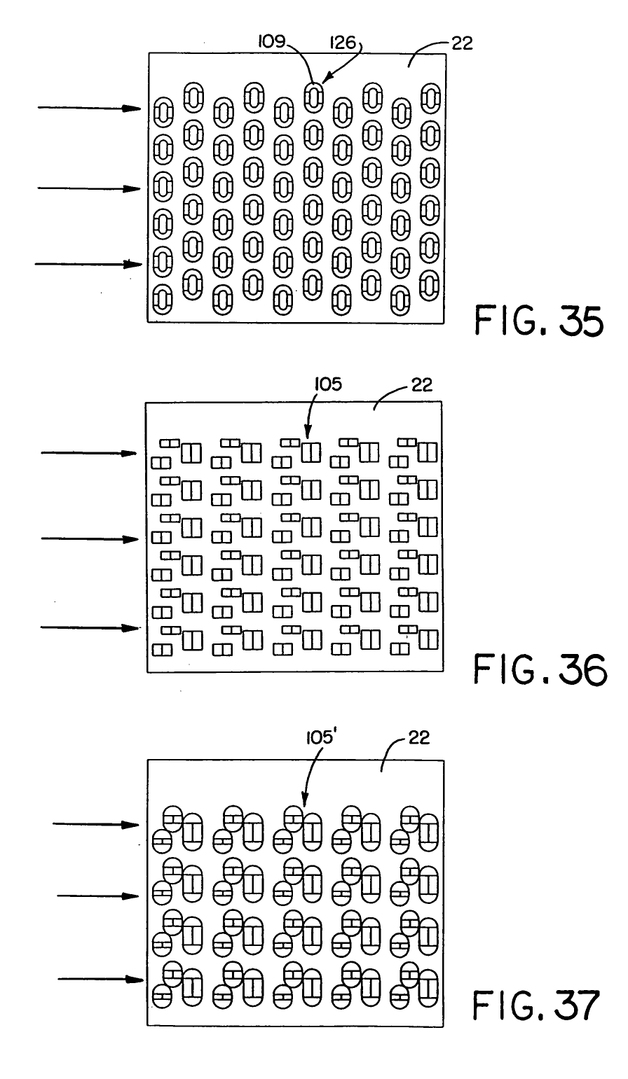

Also, the pattern of optical elements on the panel surface areas may be uniform or variable as desired to obtain a desired light output distribution from the panel surface areas. FIGS. 32 and 33 show optical elements 125 and 126 similar in shape to those shown in FIGS. 28 and 29 arranged in a plurality of generally straight uniformly spaced apart rows along the length and width of a panel surface area 22, whereas FIGS. 34 and 35 show such optical elements 125 and 126 arranged in staggered rows along the length of a panel surface area.

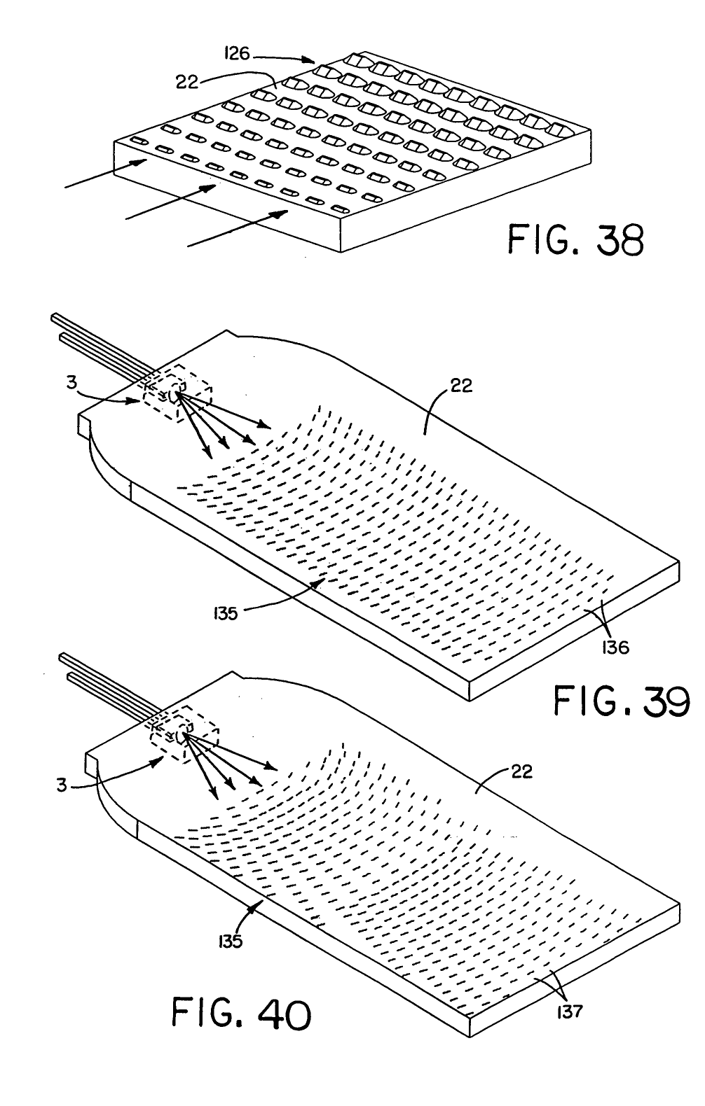

Also, the size, including the width, length and depth or height as well as the angular orientation and position or location of the optical elements may vary along the length and/or width of any given panel surface area to obtain a desired light output distribution from the panel surface area. FIGS. 36 and 37 show a random or variable pattern of different sized optical elements 105 and 105′ similar in shape to those shown in FIGS. 22 and 23, respectively, arranged in staggered rows on a panel surface area 22, whereas FIG. 38 shows optical elements 126 similar in shape to those shown in FIG. 29 increasing in size as the distance of the optical elements from the light source increases or intensity of the light decreases along the length and/or width of the panel surface area 22.

FIGS. 39 and 40 schematically show different angular orientations of optical elements 135 of any desired shape along the length and width of a panel surface area 22. In FIG. 39 the optical elements 135 are arranged in straight rows 136 along the length of the panel surface area but the optical elements in each of the rows are oriented to face the light source 3 so that all of the optical elements are substantially in line with the light rays being emitted from the light source. In FIG. 40 the optical elements 135 are also oriented to face the light source 3 similar to FIG. 39. In addition, the rows 137 of optical elements in FIG. 40 are in substantial radial alignment with the light source.

FIGS. 41 and 42 schematically show how exemplary light rays 140 emitted from a focused light source 3 insert molded or cast within a light transition area 6 of a light emitting panel assembly 5 in accordance with this invention are reflected during their travel through the light emitting panel member 7 until they impinge upon individual optical elements 98, 126 of well defined shapes on or in a panel surface area 22 causing more of the light rays to be reflected or refracted out of one side 141 of the panel member than the other side 142. In FIG. 41 the exemplary light rays 140 are shown being reflected by the reflective/refractive surfaces 101 of the optical elements 98 in the same general direction out through the same side 141 of the panel member, whereas in FIG. 42 the light rays 140 are shown being scattered in different directions within the panel member 7 by the rounded end walls 109 of the optical elements 126 before the light rays are reflected/refracted out of the same side 141 of the panel member. Such a pattern of individual optical elements of well defined shapes in accordance with the present invention can cause 60 to 70% or more of the light received through the input edge 18 of the panel member to be emitted from the same side of the panel member.

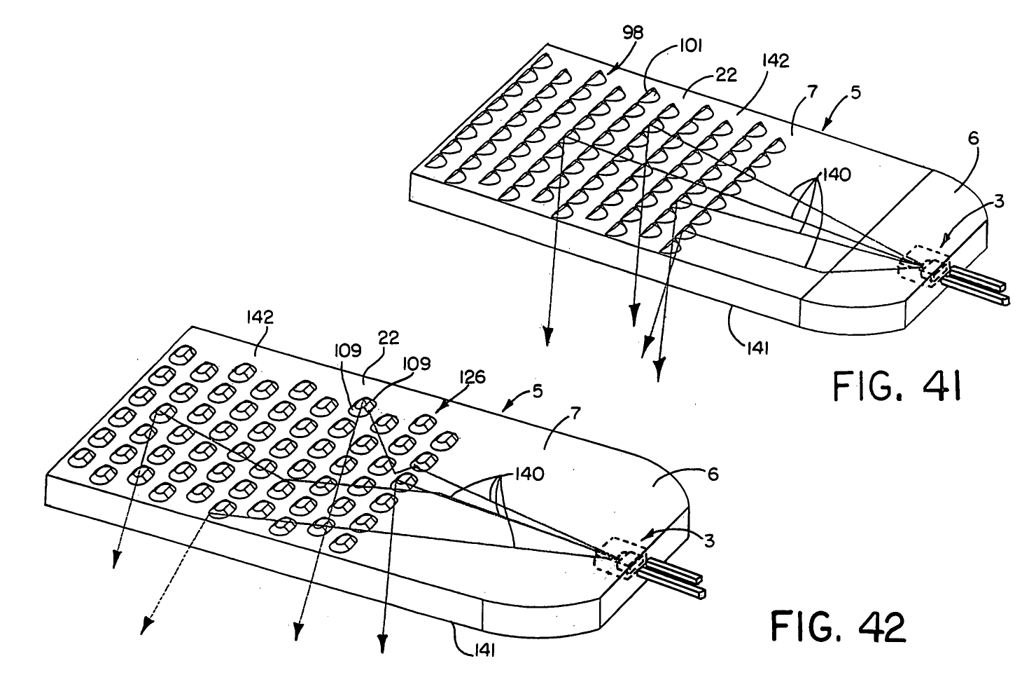

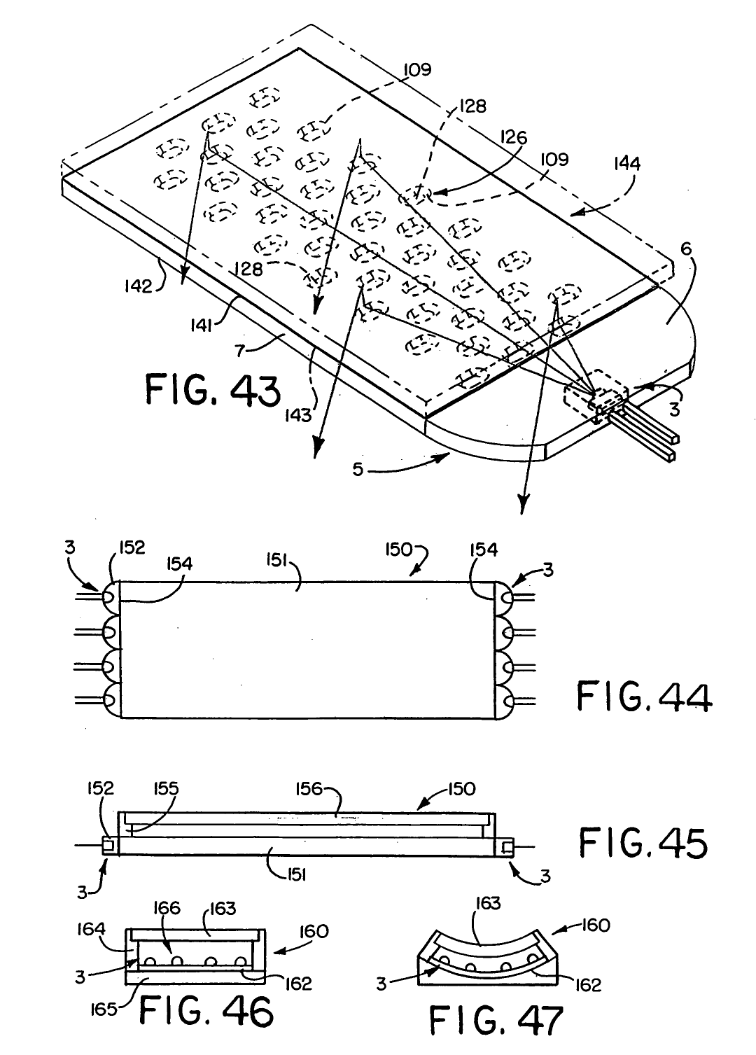

FIG. 43 schematically shows the side 141 of the light emitting panel assembly 5 of FIG. 42 from which a majority of the light is emitted placed against the front face 143 of a liquid crystal display or other signage 144 for front lighting the display/signage when the ambient light is not sufficient for proper illumination. The portions of the panel member 7 overlying the display/signage 144 are transparent without any back reflector, whereby when the light source 3 is energized, light will be emitted from the side 141 of the panel member 7 contacting the front face 143 of the display/signage 144 and then reflected back out through the panel member 7 including particularly the planar surfaces 128 on the deformities.

By selecting the optical index of refraction of the panel member 7 to closely match the substrate of the display/signage 144, the light reflected by the display/signage will pass through the planar surfaces 128 of the optical elements with minimal optical discontinuities for ease of viewing the display/signage. Also, providing a random or variable pattern of optical elements on the panel member insures that the spacing of the optical elements does not match the pixel spacing of the display so as not to produce a headlight effect.

Because the optical elements are of well defined shapes, the size, shape, location and orientation of each optical element can be individually adjusted or randomly varied at any given surface area of the panel member to spread the light output distribution uniformly across each panel surface area or obtain any other desired light output distribution at each panel surface area. Also, such optical elements may be formed in or on any surface area of the panel member or substrate in any desired manner, such as by machining using a milling or laser cutter, or by molding or stamping or the like.

The light source 3 for the panel assemblies shown in FIGS. 16, 17 and 39 through 43 may be of any suitable type as previously described. However, preferably such light source is a focused light source such as a lens end bulb, a chip from an LED, or a laser or laser diode. Alternatively such light source may be an LED, incandescent lamp or other light source having an integral collector 145 (see FIG. 16) that collects the light from the light source and focuses the light. In either case the light from the light source is preferably focused in a predetermined pattern on the input surface 146 of the light transition area 6 which directs the light at an acceptable angle for entering the light input edge 18 of the light emitting panel 7 over a substantial portion of the cross sectional area of the panel.

FIG. 44 schematically illustrates still another form of light emitting panel assembly 150 in accordance with this invention which is particularly adapted to be used for different types of phototherapy treatment by exposing various portions of the skin or eyes of a person to light being emitted from the panel assembly to treat such conditions as neonatal hyperbilirubinemia, insomnia, sleep disorders or tiredness associated with jet lag or shift work, certain types of psychiatric disorders such as seasonal affective disorder (SAD) and depression and so on. To that end, the light emitting panel assembly 150 includes a light emitting panel member 151 which may be in the shape of a pad or blanket. At one or both ends of the panel member 151 are one or more light transition areas 152 containing one or more LEDs or other light sources 3 for uniformly supplying light of any desired wavelength to the panel input edge 154 at one or both ends of the panel member. If desired, the light sources may be different colored LEDs so that the light from the LEDs can be mixed to produce virtually any desired colored light output distribution including white light from the panel member. Also, white LEDs may be used for producing a white light output distribution from the panel member.

On one or more selected panel surface areas on one or both sides of the panel member 151 are a pattern of optical elements which are not shown in FIG. 44 but may be of any of the types previously described for producing a desired light output distribution from the panel surface areas. The portion of the body of a person to receive phototherapy treatment may be placed in close association with or directly against the light emitting surface areas of the panel. Alternatively, the panel assembly 150 may be provided with molded portions 155 at strategic locations on the panel member 151 (for example at all four corners) for providing structural support for locating other parts or components such as a diffuser or lens 156 as schematically shown in FIG. 45.

FIG. 46 shows still another form of light emitting panel assembly 160 in accordance with this invention for use in phototherapy treatment or other applications in which an array of LEDs or other light sources 3 are mounted on a printed circuit board 162 for directing light through a transparent member 163 which may be a diffuser or lens. The transparent member 163 is maintained in spaced apart relation from the printed circuit board 162 and light sources 3 mounted thereon by a plurality of upstanding supports 164 on a base 165 for the circuit board. Not only does this protect the circuit board 162 and light sources 3 against damage, but also provides an air gap 166 between the light sources 3 and transparent member 163 to facilitate dissipation of any heat that is produced by the light sources.

In FIG. 46 the circuit board 162 and transparent member 163 are shown as being substantially flat. However, it will be appreciated that such circuit board 162 and transparent member 163 may also be curved as schematically shown in FIG. 47 for supporting a body part such as an arm, leg or neck of a person receiving phototherapy treatment.

The various light emitting panel assemblies disclosed herein may be used for a great many different applications including for example liquid crystal display (LCD) or other signage back lighting or lighting in general, decorative and display lighting, automotive lighting, dental lighting, phototherapy or other medical lighting, membrane switch lighting, and sporting goods and apparel lighting or the like. Also the panel assemblies may be made such that the panel members and optical elements are transparent without a back reflector. This allows the panel assemblies to be used for example to front light an LCD or other display such that the display is viewed through the transparent panel members in the manner previously described.

Predetermined patterns of individual optical elements of well defined shape each having a length and width substantially smaller than the length and width of optical substrates containing the optical elements may be formed on or in the optical substrates including films, sheets or plates using known manufacturing methods. One such known manufacturing method involves cutting a pattern of optical element shapes in a flat sheet or plate in any desired manner such as by using a milling or laser cutter and using the cut optical element shapes in the sheet or plate to form a corresponding pattern of optical elements on or in the optical substrates. A drawback to this method is the substantial length of time required to cut the optical element shapes in the flat sheet or plate.

The length of time required to make one or more patterns of optical element shapes used to form corresponding patterns of optical elements on or in optical substrates may be greatly reduced in accordance with the present invention by using a tool to cut or form one or more patterns of optical element shapes in the exterior surface of a sleeve or one or more curved substrates or films on a roll during rotation of the roll. The sleeve or curved substrates or films or at least a portion of the sleeve or curved substrates or films containing the pattern or patterns of optical element shapes is then removed from the roll and at least one pattern of the optical element shapes or a copy or inverse copy thereof is used to form a corresponding pattern of optical elements on or in optical substrates as described hereafter.

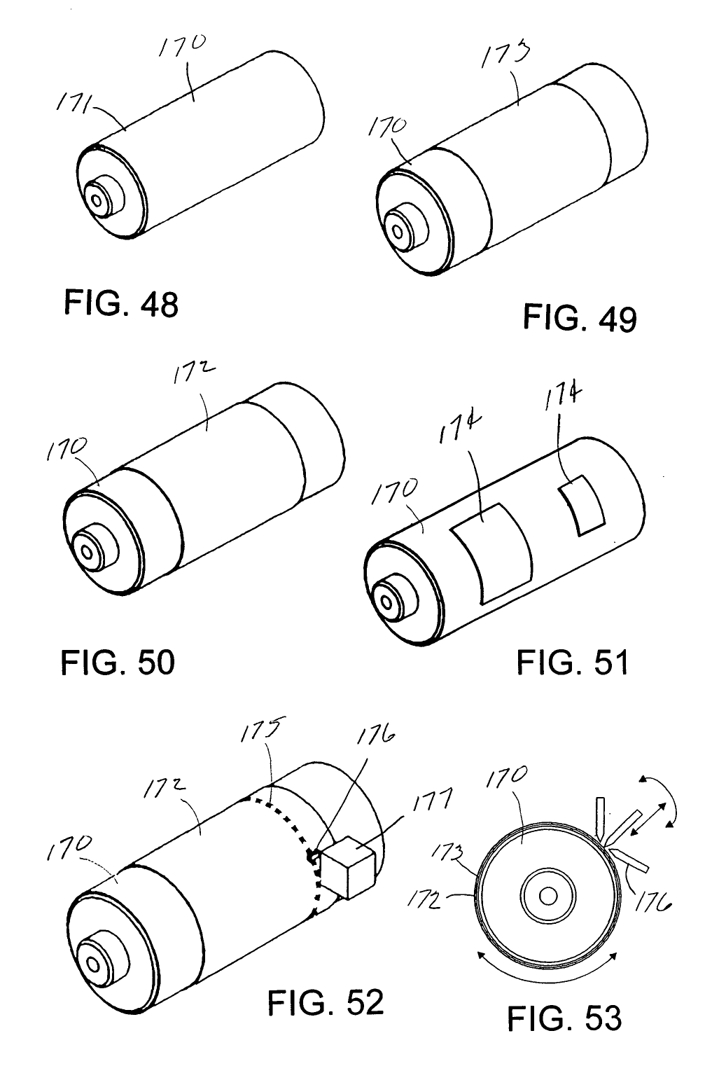

FIG. 48 shows one such roll 170 which may have a precision exterior surface 171. Alternatively, the roll may be coated with a suitable material such as nickel or a nickel alloy as by an electroplating or other deposition process or the like and machined, ground, polished, fly cut or turned to the desired precision finish.

A sleeve 172 made of a suitable material such as nickel or a nickel alloy may be a preformed sleeve that is placed over the roll 170 as shown in FIG. 50. Alternatively the sleeve 172 may be formed in situ on the roll by applying a coating on the roll and having the coating cure or solidify on the sleeve. For example, the coating may be deposited on the roll by a chemical, chemical vapor, electrolytic or other deposition process. If the sleeve 172 is formed in situ on the roll 170, a release coating 173 may be applied to the roll as shown in FIG. 49 before the sleeve is formed on the roll to facilitate removal of the sleeve from the roll after the cutting or forming operation. Also the roll may have a Teflon coating or the like which may eliminate the need for applying a release coating to the roll.

Instead of providing an entire sleeve on the roll, one or more curved substrates or films 174 (hereafter collectively substrates) made from a suitable material such as nickel or a nickel alloy may be attached to the exterior surface of the roll 170 as schematically shown in FIG. 51 as by laminating, adhesively bonding, or mechanically fastening the substrates to the roll.

The exterior surface of the sleeve 172 or curved substrates 174 may be polished to a desired finish using a suitable polishing material such as a diamond paste, a diamond impregnated polishing belt or a diamond turning lathe or the like. Alternatively, the exterior surface of the sleeve or curved substrates may be ground, machined, fly cut or turned to provide a desired precision finish.

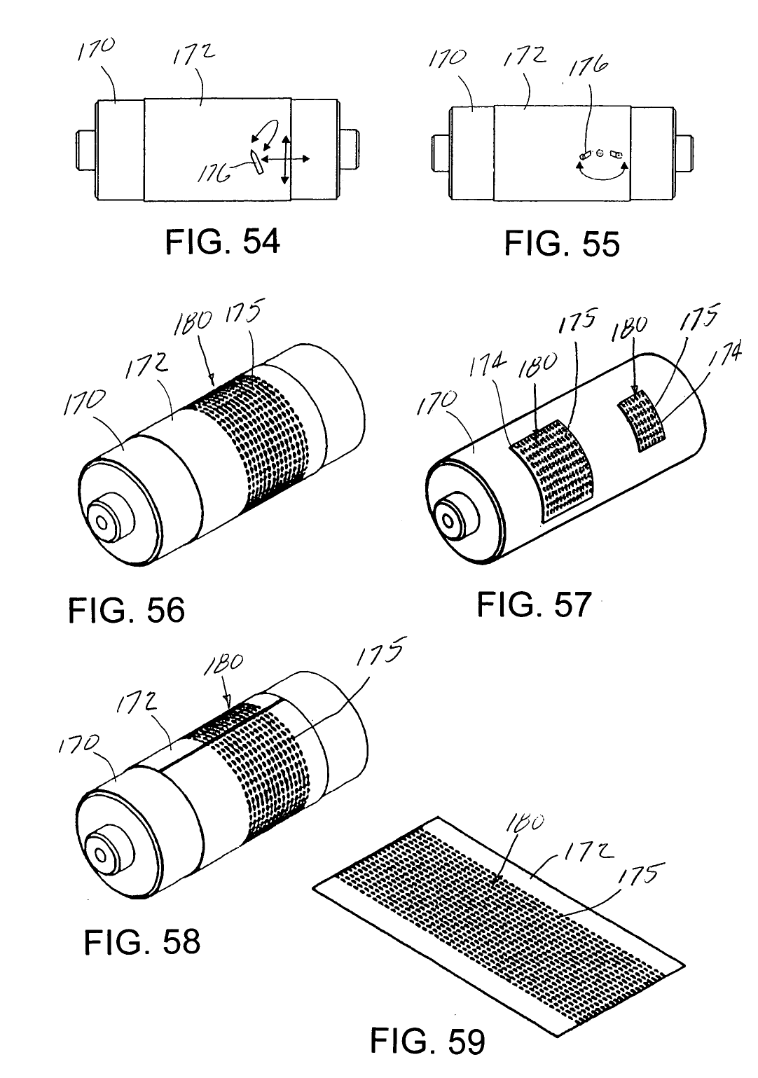

One or more predetermined patterns of optical element shapes 175 may be cut or formed in the exterior surface of the sleeve 172 or curved substrates 174 by moving a tool 176, schematically shown in FIGS. 52 through 55, into and out of engagement with the sleeve (or curved substrates) during rotation of the roll 170. For example, the tool 176 may be a diamond tool that is moved into and out of engagement with the sleeve or curved substrates up to 10,000 times per minute while the roll is being rotated up to 1,000 revolutions per minute in either the clockwise or counterclockwise direction as viewed in FIG. 53 during the cutting or forming steps. Also the angle of orientation and/or position of the diamond tool relative to the surface of the roll may be varied during or between the cutting or forming steps. For example, the tool 176 may be moved longitudinally or transversely relative to the roll as schematically shown in FIG. 54 during or between the cutting or forming steps. Also the tool 176 may be angularly adjusted relative to the roll as schematically shown in FIGS. 53-55 during or between the cutting or forming steps. These movements of the tool may be controlled by a controller 177, schematically shown in FIG. 52, which may also be used to control roll rotation.

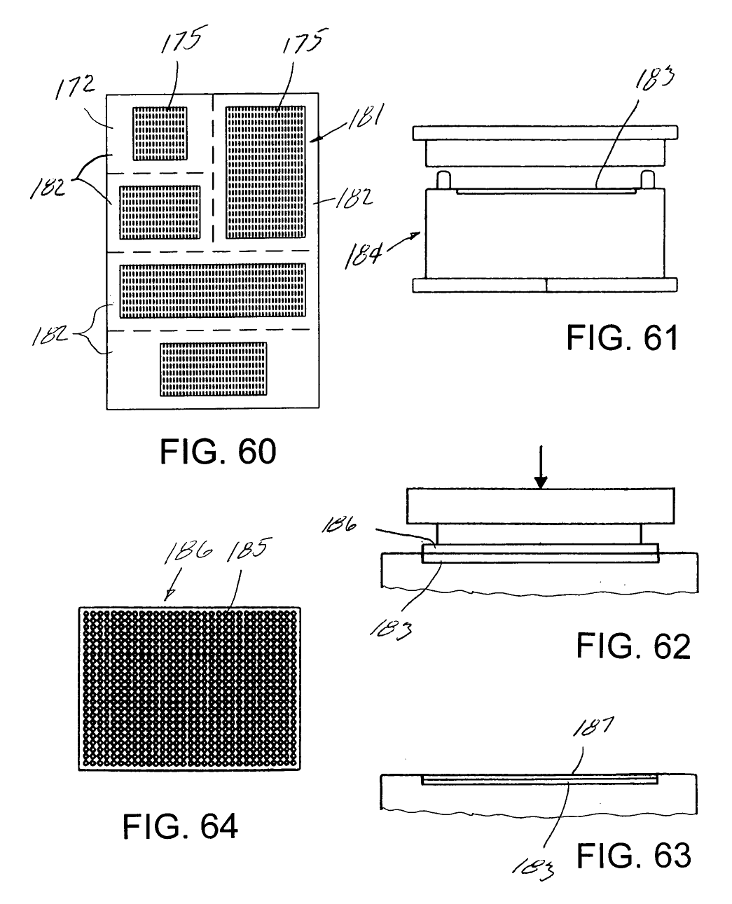

FIG. 56 schematically shows one pattern 180 of optical element shapes 175 cut or formed in the exterior surface of sleeve 172, whereas FIG. 57 schematically shows one such pattern 180 of optical element shapes cut or formed in two curved substrates 174 on roll 170. Sleeve 172 or curved substrates 174 may be substantially larger than most optical substrates, in which event multiple patterns 181 of optical element shapes 175, schematically shown in FIG. 60, may be cut or formed in the sleeve or curved substrates on the roll at the same time or at different times depending on whether only a portion of the sleeve or curved substrates with the desired pattern or patterns of optical element shapes is removed from the sleeve or curved substrates while the sleeve or curved substrates are still on the roll or the entire sleeve or curved substrates are removed from the roll after the cutting or forming operation.

The optical element shapes 175 may only have two surfaces, one of which may be curved and the other of which may be flat, and both surfaces may come together to form a ridge as schematically shown in FIGS. 16-21. Alternatively, both surfaces may be curved. Moreover, the optical element shapes may include more than two surfaces. Further, the curved surface or surfaces may be spherical, elliptical or aspheric.

These optical element shapes may cover substantially the entire surface of the portion or portions of the sleeve or curved substrates containing the pattern or patterns of optical element shapes as schematically shown in FIGS. 56-60. Also the pattern or patterns of optical element shapes may be predetermined patterns or random patterns as desired. Further, the optical element shapes may overlap, intersect or interlock one another, and may vary in size, shape, placement, density, angle, depth, height and/or type as desired.

After a desired number of optical element shapes or patterns of optical element shapes are cut or formed in the sleeve or one or more curved substrates, if desired the roll may be turned lengthwise 180° and the same tool or a different tool may be used to cut or form additional optical element shapes in the exterior surface of the sleeve or curved substrates.

These additional optical element shapes may face in a direction opposite to the optical element shapes that were cut or formed in the sleeve or substrates prior to turning the roll lengthwise. Also at least some of these additional optical element shapes may be cut or formed in the sleeve or substrates between at least some of the optical element shapes that were cut or formed in the sleeve or substrates prior to turning the roll lengthwise.

After the desired number and patterns of optical element shapes are cut or formed in the sleeve or curved substrates on the roll, the roll may be stopped to permit removal of at least the portion of the sleeve or curved substrates containing at least one pattern of the optical element shapes to be used in making a corresponding pattern of optical elements on or in suitable optical substrates. If the entire sleeve 172 is to be removed from the roll 170 at one time, the sleeve may be cut lengthwise as schematically shown in FIG. 58 to facilitate its removal from the roll.

Then the sleeve 172 or substrates 174 or one or more portions 182 removed from the sleeve or substrates containing the desired pattern or patterns of optical element shapes or a copy or inverse copy of the optical element shapes may be formed in any desired shape and used to form a corresponding pattern of optical elements on or in optical substrates. FIGS. 59 and 60 show the sleeve or sleeve portions or substrates or copies or inverse copies thereof formed into a substantially flat sheet. However, the sleeve or sleeve portions or substrates or copies or inverse copies thereof may also be formed into any desired three-dimensional shape and used to produce a corresponding pattern of optical elements on or in a surface of optical substrates that are three-dimensionally shaped as shown, for example, in FIG. 8.

The sleeve or sleeve portions or substrates containing the desired pattern or patterns of optical element shapes or copies or inverse copies thereof may be used in production tooling or as a master for making production tooling as by a deposition process or the like. The production tooling may be used to form a corresponding pattern of optical elements on or in optical substrates by a molding process. For example, FIG. 61 shows the tooling 183 placed in an injection mold 184 for molding optical elements 185 on or in an optical substrate 186 as schematically shown in FIG. 64; FIG. 62 shows the optical elements 185 on or in optical substrate 186 of FIG. 64 formed by applying heating and pressing optical substrate 186 against the optical element shapes in the tooling 183; and FIG. 63 shows the optical elements 185 on or in optical substrate 186 formed by applying a flowable optical substrate material 187 over the optical element shapes in the tooling 183 and having the flowable optical substrate material cure or solidify before removing the cured or solidified optical substrate material from the tooling. The flowable optical substrate material may, for example, be a self-curing material or an untraviolet or other radiant cured material.

Although the invention has been shown and described with respect to certain preferred embodiments, it is obvious that equivalent alterations and modifications will occur to others skilled in the art upon the reading and understanding of the specification. In particular, with regard to the various functions performed by the above described components, the terms (including any reference to a “means”) used to describe such components are intended to correspond, unless otherwise indicated, to any component which performs the specified function of the described component (e.g., that is functionally equivalent), even though not structurally equivalent to the disclosed component which performs the function in the herein illustrated exemplary embodiments of the invention. Also all of the disclosed functions may be computerized and automated as desired. In addition, while a particular feature of the invention may have been disclosed with respect to only one embodiment, such feature may be combined with one or more other features as may be desired and advantageous for any given or particular application.

What is claimed is:

1. A method of making at least one pattern of optical elements on or in an optical substrate comprising the steps of providing a sleeve on a roll, using a tool to cut or form at least one pattern of optical element shapes in an exterior surface of the sleeve, removing at least a portion of the sleeve containing at least the one pattern of optical element shapes from the roll, and using at least the one pattern of optical element shapes in the removed portion of the sleeve or on a copy or inverse copy of the optical element shapes in the removed portion of the sleeve to form a corresponding pattern of optical elements on or in an optical substrate.

2. The method of claim 1 wherein the optical element shapes in the removed portion of the sleeve are used to make the corresponding pattern of optical elements on the substrate.

3. The method of claim 1 wherein the optical element shapes on a copy or inverse copy of the optical element shapes in the removed portion of the sleeve are used to make a corresponding pattern of optical elements in the substrate.

4. The method of claim 1 wherein the optical elements are formed on or in the substrate by a molding process.

5. The method of claim 1 wherein the removed portion of the sleeve is used in production tooling.

6. The method of claim 1 wherein the removed portion of the sleeve is used as a master for production tooling.

7. The method of claim 6 wherein a deposition process is used.

8. The method of claim 1 wherein the optical elements are formed on or in the substrate by heating and pressing the substrate against the optical element shapes in the removed portion of the sleeve or on a copy or inverse copy.

9. The method of claim 1 wherein the optical elements are formed on or in the substrate by applying a flowable substrate material over the optical element shapes in the removed portion of the sleeve or on a copy or inverse copy, having the flowable substrate material cure or solidify, and removing the cured or solidified substrate material from the removed portion of the sleeve or the copy or inverse copy.

10. The method of claim 9 wherein the flowable substrate material is a self-curing material, a heat cured material, or an ultraviolet or radiant cured material.

11. The method of claim 1 wherein the sleeve is a preformed sleeve that is placed over the roll.

12. The method of claim 1 wherein the sleeve is deposited on the roll.

13. The method of claim 1 wherein the sleeve is a cured or solidified coating on the roll.

14. The method of claim 1 wherein a release coating is applied to an exterior surface of the roll prior to providing the sleeve on the roll.

15. The method of claim 14 wherein the sleeve is formed in situ on the roll by depositing a metal onto the release coating.

16. The method of claim 15 wherein the metal is deposited onto the release coating by a deposition process.

17. The method of claim 1 wherein the sleeve is made of nickel or a nickel alloy.

18. The method of claim 1 wherein the substrate is a film, sheet or plate.

19. The method of claim 1 further comprising the step of polishing, grinding, machining, fly cutting or turning an exterior surface of the sleeve prior to the cutting or forming steps.

20. The method of claim 19 wherein the exterior surface of the sleeve is polished using a paste, polishing belt or turning lathe.

21. The method of claim 1 wherein the tool is moved into and out of engagement with an exterior surface of the sleeve to form the optical element shapes while rotating the roll.

22. The method of claim 21 wherein the tool is moved longitudinally or transversely relative to the roll during or between cutting or forming steps.

23. The method of claim 21 wherein the tool is angularly adjusted relative to the roll during or between cutting or forming steps.

24. The method of claim 1 wherein multiple patterns of optical element shapes are cut or formed in the sleeve.

25. The method of claim 1 wherein the entire sleeve is removed from the roll after the cutting or forming step.

26. The method of claim 25 wherein the sleeve is cut lengthwise to remove the sleeve from the roll.

27. The method of claim 25 wherein the portion of the sleeve containing at least the one pattern of optical element shapes is removed from the sleeve after the sleeve has been removed from the roll.

28. The method of claim 1 wherein a controller is used to control movements of the tool during or between cutting or forming steps.

29. The method of claim 1 wherein the roll is machined, ground, polished, fly cut or turned to a precision finish prior to providing the sleeve on the roll.

30. The method of claim 1 wherein a metal coating is applied to the roll and machined, ground, polished, fly cut or turned to a precision finish prior to providing the sleeve on the roll.

31. The method of claim 1 wherein multiple patterns of optical element shapes are cut or formed in the sleeve, and multiple sleeve portions each containing at least one pattern of optical element shapes are removed from the sleeve.

32. The method of claim 31 wherein the sleeve is removed from the roll before the sleeve portions are removed from the sleeve.

33. The method of claim 1 wherein at least the one pattern of optical element shapes in the sleeve is a random pattern.

34. The method of claim 1 wherein at least the one pattern of optical element shapes in the sleeve is a predetermined pattern.

35. The method of claim 1 wherein at least some of the optical element shapes overlap, intersect or interlock one another.

36. The method of claim 1 wherein the optical element shapes vary in at least one of the following characteristics: size, shape, placement, density, angle, depth, height and type.

37. The method of claim 1 wherein the optical element shapes cover substantially the entire surface of the portion of the sleeve containing at least the one pattern.

38. The method of claim 1 wherein the roll is rotated during the cutting or forming steps.

39. The method of claim 38 wherein a controller is used to control the rotation of the roll.

40. The method of claim 38 wherein a controller is used to control tool movements and roll rotation.

41. The method of claim 38 wherein the tool is moved into and out of engagement with the sleeve at least once per second during rotation of the roll to cut or form the optical element shapes in the sleeve.

42. The method of claim 38 wherein the rotation of the roll is greater than one revolution per minute during the cutting or forming steps.

43. The method of claim 1 further comprising the steps of forming the removed portion of the sleeve or a copy or inverse copy thereof into a predetermined shape, and using the shaped sleeve portion or copy or inverse copy thereof to produce the substrate.

44. The method of claim 1 wherein after at least some of the optical element shapes are cut or formed in the exterior surface of the sleeve, the roll is turned lengthwise 180° and at least some additional optical element shapes are cut or formed in the exterior surface of the sleeve on the roll.

45. The method of claim 44 wherein the additional optical element shapes that are cut or formed in the sleeve face in a direction opposite to the optical element shapes that were cut or formed in the sleeve prior to turning the roll lengthwise.

46. The method of claim 44 wherein at least some of the additional optical element shapes are cut or formed in the sleeve between at least some of the optical element shapes that were cut or formed in the sleeve prior to turning the roll lengthwise.

47. The method of claim 1 wherein the optical element shapes only have two surfaces.

48. The method of claim 47 wherein at least one of the surfaces is curved.

49. The method of claim 48 wherein the curved surface is spherical, elliptical, or aspheric.

50. The method of claim 47 wherein both of the surfaces are curved.

51. The method of claim 47 wherein one of the surfaces is curved and the other surface is flat.

52. The method of claim 47 wherein the surfaces come together to form a ridge.

53. The method of claim 1 wherein the optical element shapes have at least two surfaces, and at least one of the surfaces is curved.

54. The method of claim 53 wherein the curved surface is spherical, elliptical, or aspheric.

55. The method of claim 53 wherein at least two of the surfaces are curved.

56. The method of claim 53 wherein at least one other surface is flat.

57. The method of claim 53 wherein at least the two surfaces come together to form a ridge.

58. A method of making at least one pattern of optical elements on or in an optical substrate comprising the steps of applying a coating to form a sleeve on a roll, moving a tool into and out of engagement with an exterior surface of the sleeve to cut or form at least one pattern of optical element shapes in the sleeve, removing at least a portion of the sleeve containing at least the one pattern of optical element shapes from the roll, and using at least the one pattern of optical element shapes in the removed portion of the sleeve or a copy or inverse copy of the optical element shapes in the removed portion of the sleeve to form a corresponding pattern of optical elements on or in an optical substrate.

59. The method of claim 58 wherein the roll is rotated during the cutting or forming steps.

60. The method of claim 58 wherein the substrate is a film, sheet or plate.

61. The method of claim 58 further comprising the steps of forming the removed portion of the sleeve or a copy or inverse copy thereof into a predetermined shape, and using the shaped removed portion of the sleeve or a copy or inverse copy thereof to produce the substrate.

62. A method of making at least one pattern of optical elements on or in an optical substrate comprising the steps of providing at least one curved substrate or film on a roll, rotating the roll, using a tool to cut or form at least one pattern of optical element shapes in an exterior surface of the substrate or film, removing at least a portion of the substrate or film containing at least the one pattern of optical element shapes from the roll, and using at least the one pattern of optical element shapes in the removed portion of the substrate or film or on a copy or inverse copy of the optical element shapes in the removed portion of the substrate or film to form a corresponding pattern of optical elements on or in an optical substrate.

63. The method of claim 62 wherein the optical element shapes in the removed portion of the substrate or film are used to make the corresponding pattern of optical elements on the optical substrate.

64. The method of claim 62 wherein the optical element shapes on a copy or inverse copy of the optical element shapes in the removed portion of the substrate or film are used to make a corresponding pattern of optical elements in the optical substrate.

65. The method of claim 62 wherein the removed portion of the substrate or film is used in production tooling.

66. The method of claim 62 wherein the removed portion of the substrate or film is used as a master for production tooling.

67. The method of claim 62 wherein the substrate or film is made of nickel or a nickel alloy.

68. The method of claim 62 wherein the optical substrate is a film, sheet or plate.

69. The method of claim 62 wherein the tool is moved into and out of engagement with an exterior surface of the substrate or film to form the optical element shapes while rotating the roll.

70. The method of claim 69 wherein the tool is moved longitudinally or transversely relative to the roll during or between cutting or forming steps.

71. The method of claim 69 wherein the tool is angularly adjusted relative to the roll during or between cutting or forming steps.

72. The method of claim 62 wherein multiple patterns of optical element shapes are cut or formed in the substrate or film.

73. The method of claim 62 wherein a controller is used to control movements of the tool and roll during or between cutting or forming steps.

74. The method of claim 62 wherein patterns of optical element shapes are cut or formed in a plurality of substrates or films on the roll.

75. The method of claim 62 wherein the optical element shapes cover substantially the entire surface of the portion of the substrate or film containing at least the one pattern.

76. The method of claim 62 further comprising the steps of forming the removed portion of the substrate or film or a copy or inverse copy thereof into a predetermined shape, and using the shaped portion of the substrate or film or a copy or inverse copy thereof to produce the optical substrate.

77. The method of claim 62 wherein after at least some of the optical element shapes are cut or formed in the exterior surface of the substrate or film, the roll is turned lengthwise 180° and the same tool is used to cut or form at least some additional optical element shapes in the exterior surface of the substrate or film on the roll while rotating the roll.

78. The method of claim 77 wherein the additional optical element shapes that are cut or formed in the substrate or film face in a direction opposite to the optical element shapes that were cut or formed in the substrate or film prior to turning the roll lengthwise.

79. The method of claim 77 wherein at least some of the additional optical element shapes are cut or formed in the substrate or film between at least some of the optical element shapes that were cut or formed in the substrate or film prior to turning the roll lengthwise.

80. The method of claim 62 wherein the optical element shapes only have two surfaces.

81. The method of claim 80 wherein at least one of the surfaces is curved.

82. The method of claim 81 wherein the curved surface is spherical, elliptical or aspheric.

83. The method of claim 80 wherein both of the surfaces are curved.

84. The method of claim 80 wherein one of the surfaces is curved and the other surface is flat.

85. The method of claim 80 wherein the surfaces come together to form a ridge.

86. The method of claim 62 wherein the optical element shapes have at least two surfaces, and at least one of the surfaces is curved.

87. The method of claim 86 wherein the curved surface is spherical, elliptical, or aspheric.

88. The method of claim 86 wherein at least two of the surfaces are curved.

89. The method of claim 86 wherein at least one other surface is flat.

90. The method of claim 86 wherein at least the two surfaces come together to form a ridge.
